(19) United States
(12) Patent Application Publication
(10) Pub. No.: US 2017/0220768 A1
(43) Pub. Date: Aug. 3, 2017

(54) SYSTEM AND METHOD FOR DYNAMIC DISTRIBUTED PHARMACY TRANSACTIONAL NETWORK PROCESSING

(71) Applicant: POKITDOK, INC., San Mateo, CA (US)

(72) Inventors: Theodore C. TANNER, JR., San Mateo, CA (US); Brian CORBIN, San Mateo, CA (US); Mallory NELSON, San Mateo, CA (US); Faride BEAUBIEN, San Mateo, CA (US)

(21) Appl. No.: 15/013,174

(22) Filed: Feb. 2, 2016

(51) Int. Cl. G06F 19/00

(52) U.S. Cl. CPC G06F 19/3462; G06F 19/322; G06F 19/328

(57) ABSTRACT

A system and method for pharmacy processing are provided. The system and method provide individuals making decisions for a member, such as what drug to prescribe, insight into a member's pharmacy eligibility, formularies, prescription history, etc. prior to prescribing or dispensing medication. The dynamic distributed pharmacy transactional network processing may combine multiple data feeds to bring pharmacy transactions, transparency, functionality to members, prescribers, pharmacists and employers.

### FIELD

The disclosure relates generally to a system and method for processing health care transactions and in particular to processing pharmacy transactions.

### BACKGROUND

Half of the US population takes at least one prescription medication, equating to 2.6 billion drugs prescribed annually. More than $263 billion (9.4% of total healthcare expenditure) is spent on prescription medication and this number is increasing every year. Most Americans have prescription insurance that helps them pay for medication. This pharmacy benefit is managed by PBMs (pharmacy benefit managers). Although PBMs are supposed to reduce the cost of prescription medication, they actually account for a large percentage of the overall bill. With annual revenues over $250 billion, PBMs continue to use unethical business practices to increase the bottom line. This includes spread pricing (charging the plan more than they pay the pharmacy), data hoarding (siloing member benefits), rebates (kickbacks from the pharmaceutical companies), etc. (as discussed at https://www.bcnepa.com/OurCompany/News/ExpertCommentary/Commentary.aspx?id=4150 which is incorporated herein by reference).

Pharmacy Benefit Management Industry

Medical benefits are often offered by employers or can be purchased via a health insurance marketplace and managed by health plans. Similar to medical benefits, a member can obtain pharmacy benefits through their employer's health plan or independently through a health insurance marketplace (a pharmacy carve-out). The pharmacy benefit management industry is comprised of several key players as shown in FIG. 1. Specifically, health plans manage the medical benefits and pharmacy benefit managers (PBMs) manage the prescription benefits for a health plan or employer. The PBMs are responsible for negotiating drug prices with pharmacies and drug companies, maintaining the formulary, processing pharmacy claim payments (adjudication) and maintaining prescription history. Technology vendors are often used by PBMs to translate X12/NCPDP formats and process transactions such as pharmacy eligibility checks or claims. The pharmacies order prescriptions, dispense prescriptions and bill PBMs for payment. Prescribers (a provider writing the prescription) write the prescriptions and send to pharmacies electronically or via the member on a paper prescription.

How Pharmacy Benefits are Currently Determined

Currently, pharmacy benefits are determined by understanding what the member of the pharmacy benefit is eligible for, how much they have to pay out of pocket such as a deductibles and copayments, understanding which pharmacy is in network to send their prescription to and referencing their formulary. To find out if a medication is covered, one must first verify if a member is eligible for pharmacy benefits, reference a PDF or hard copy of their formulary or call their insurance company. The formulary is difficult for the average person to interpret because drugs are listed under therapeutic classes that the member may not comprehend.

What is a Formulary?

A formulary is a list of medications that are approved by the U.S. Food and Drug Administration and covered by the member's health plan. An example of a formulary is shown in FIG. 2. The medications are chosen to be on the formulary based on efficacy, safety and cost effectiveness and may include tier levels for preferred medications. The lower the tier, the less expensive the copay is for the member. Most generic medications are lower tiered and brand name medications are higher tiered. Specialty medications are another class of drugs and can fall into their own tier due to cost, special monitoring or administration. Formularies can also contain restrictions such as a prior authorization, step therapy and quantity limitations. The prior authorization process determines if the medication is medically necessary. Step therapy is a requirement for the member to try and fail when using a less expensive or preferred therapy first.

FIGS. 2 and 3 show examples of two different formularies. Each of these forumlaries are described in more detail at https://www.nyu.edu/content/dam/nyu/hr/documents/benefitsforms/CVS-CaremarkPrimaryDrugList.pdf and http://www.cigna.com/iwov-resources/medicare-2015/docs/formulary-ea-az.pdf which are incorporated herein by reference. The italicized drug names are considered lower tier medications and the uppercase drug names are classified as higher tier. There is also another list of medications (not pictured above) that is categorized in the specialty tier. These are medications that are really expensive (like chemotherapy or HIV drugs) or that require special monitoring or administration. About half of the specialty medications are covered under medical benefit instead of pharmacy benefit (mostly cancer drugs).

When prescribers are prescribing a medication, they do not know what medications are covered under the member's formulary. When the prescription is sent to the pharmacy, the pharmacist doesn't know if the prescription is covered until they submit a claim to the PBM. If the claim is rejected, it indicates that the member is not covered for that medication. If the member can't afford to pay for the medication out of pocket, they may not purchase it. This cost related non-adherence leads to bad outcomes for the member, such as hospitalization or even death. In addition, prescribers may not have insight into whether an alternative and covered medication is an option (approved by health plan) for the member.

Traditionally PBMs have operated utilizing many manual processes and outsourced key processes. The member or independent healthcare provider would have to call the insurance or reference a formulary to determine if a medication is covered and what the copay is. With advances in technology, these processes can be performed electronically such as verifying a member's pharmacy benefits. Outsourcing electronic connections, such as eligibility and claims processing, creates data silos and makes it even more difficult to have access to member data electronically. Electronic connections for eligibility and claims have in the past been available in some hospital systems. PBMs have recently been scrutinized for engaging in not so ethical business practices. One such practice known as “spread pricing” (an example of which is shown in FIG. 4) that occurs when the PBM charges a health plan more than they pay the pharmacy for filling it. More specifically, PBMs may not disclose how much they are paying the pharmacy to complete a prescription. Spread pricing averages about $5 per prescription but can be as much as $200 (further details of which are described at http://www.whorunsmydrugplan.com/index.php/spread-pricing which is incorporated herein by reference). Another example is how PBMs are unwilling to provide access to member pharmacy benefits to stakeholder such as employers and medical providers, having them resort to manual processes. Another provision in PBM contracts concerns maximum allowable cost (MAC) provisions. MAC pricing puts a cap on how much a pharmacy can be reimbursed for a drug. Unfortunately, sometimes these reimbursements are less than the drug costs to the pharmacy. Therefore, the pharmacy has to dispense the drug at a loss so that the member can receive their needed medication.

### BRIEF DESCRIPTION OF THE DRAWINGS

FIG. 1 illustrates the existing pharmacy benefit management industry;

FIG. 2 illustrates a pharmacy formulary example;

FIG. 3 illustrates a Cigna formulary example;

FIG. 4 an example of a currently existing spread pricing pharmacy system;

FIG. 5 illustrates an example of a health system that may incorporate a distributed pharmacy transaction processing component;

FIG. 6 illustrates a passthrough PBM model;

FIG. 7 illustrates an example of a pharmaceutical company user interface;

FIG. 8 illustrates an example of a hospital user interface;

FIG. 9 illustrates an example of a formulary lookup tool user interface that may be generated by the distributed pharmacy transaction processing component;

FIG. 10 illustrates an example of the distributed pharmacy transaction processing component being used to access pharmacy plan IDs;

FIG. 11 illustrates more details of the distributed pharmacy transaction processing component;

FIG. 12 illustrates a method for distributed pharmacy transaction processing;

FIG. 13 illustrates an example of a drug formulary and product information in a JSON data format that may be used by the distributed pharmacy transaction processing component;

FIG. 14 illustrates pharmacy plan information stored in a health graph data store that may be part of the health system shown in FIG. 5; and

FIG. 15 illustrates an example of drug formulary information linked with drug product information that may be achieved using the distributed pharmacy transaction processing component.

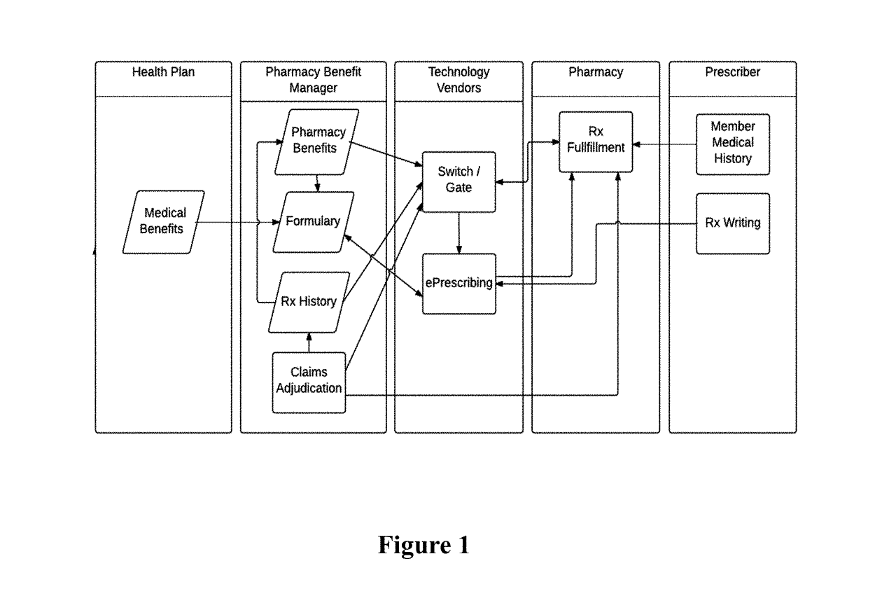

### DETAILED DESCRIPTION OF ONE OR MORE EMBODIMENTS

The disclosure is particularly applicable to a pharmacy transaction processing system and method as described below using a cloud based computer architecture and it is in this context that the disclosure will be described. It will be appreciated, however, that the system and method has greater utility since the pharmacy transaction processing system and method may be implemented in various different manners that are all within the scope of the disclosure.

Individuals making decisions for a member such as what drug to prescribe, should have insight into a member's pharmacy eligibility, formularies, prescription history, etc. prior to prescribing or dispensing medication. The dynamic distributed pharmacy transactional network processing will combine multiple data feeds to bring pharmacy transactions, transparency, functionality to members, prescribers, pharmacists and employers. By allowing an electronic connection to a member's pharmacy benefits at the prescriber's office, the prescriber can have a better understanding of which drugs are covered and prescribe the right therapy. If a pharmacist has access to the member's formulary when a claim is rejected because, “drug/product is not covered”, they can look up a therapeutic alternative that is covered. The pharmacist can call the prescriber and get the medication changed to a more viable option. This would improve member adherence, because the member could now afford their medication and reduce costs over all.

Members should easily have insight into their medical and pharmacy benefits. They should have visibility into where they are in their pharmacy deductible prior to picking up a prescription. A member can verify that the pharmacy their prescription was sent to is in network, that the prescription is covered and what they expect to pay out of pocket. This electronic connection to a member's pharmacy formulary and benefit could also be used by pharmaceutical companies to help their members understand how much their copay is for a medication. Currently, pharmaceutical websites may state, “Call your insurance to determine pharmacy benefits”. Having an electronic connection to member pharmacy benefits give the member insight into how much their copay is for the drug.

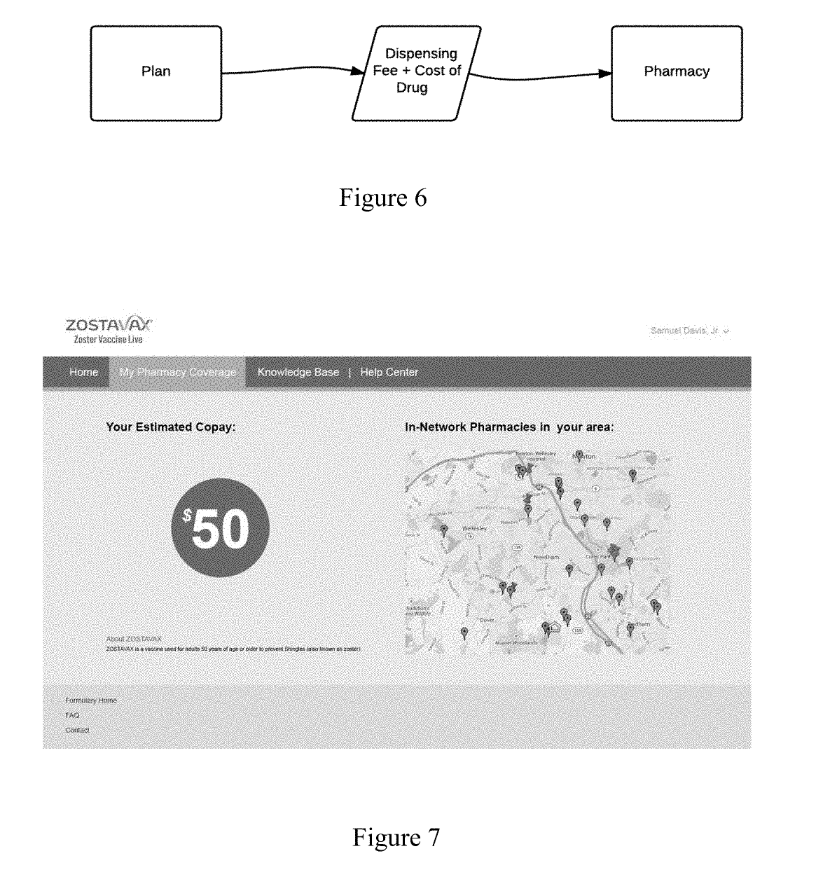

Since pharmacies are often faced with dispensing at a loss, as shown in FIG. 6, a better reimbursement strategy is to give the pharmacy a dispensing fee for every prescription rather than the current complicated reimbursement equations currently utilized by PBMs. For example, if the medication costs $50, the pharmacy would be reimbursed the ($50) cost of the medication+$10 dispensing fee. This would be a passthrough model and provide more transparency to the payer (insurance company/self-insured employer). We will also illustrate a methodology where false and inflated cost structures can be recalculated within the network behaviors.

The dynamic distributed pharmacy transaction network processing completes the processing functionality from a data perspective for the company. The system and method provides connections to all necessary pharmacy benefit data to create APIs which will then increase transaction volume as well as data volume. In addition to accessing the pharmacy data, the system and method may include additional pharmacy functionality such as claims processing, retail pharmacy, building the transparent/pass through PBM model and being able to combine all medical & pharmacy benefit/claim data for a given member, provider, payer, etc.

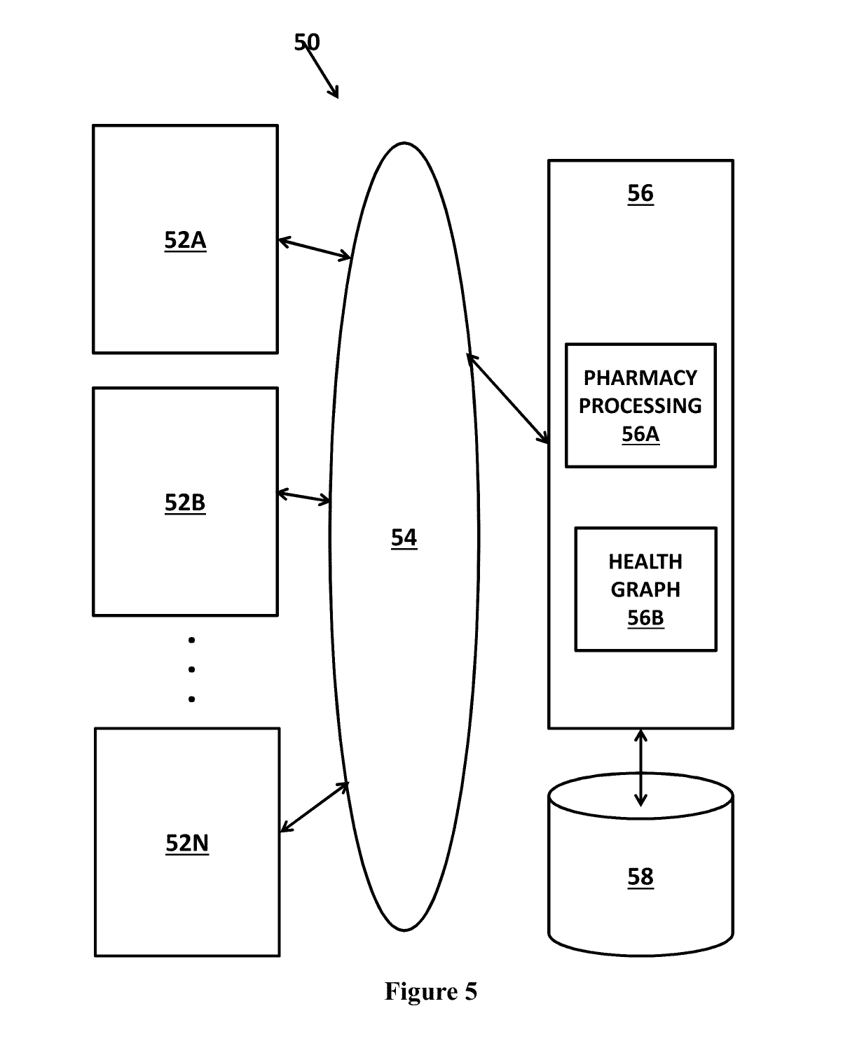

FIG. 5 illustrates an example of a health system 50 that may incorporate a distributed pharmacy transaction processing component 56A. The distributed pharmacy transaction processing component 56A may also be implemented one its one computer resources or it may also be integrated into various other systems and the disclosure is not limited to any particular implementation of the distributed pharmacy transaction processing component 56A.

The system 50 may have one or more computing devices 52, such as computing device 52A, computing device 52B, . . . , computing device 52N as shown in FIG. 5, that couple and connect to a health system 56 over a communication link 54 and allow a user to interact and exchange data with the health system 56. The interactions with the health system (and in particular the pharmacy processing component 56A) may include accessing information by a user about the pharmacy benefit for a particular patient, claims processing, retail pharmacy, building a transparent/pass through PBM model and/or being able to combine all medical & pharmacy benefit/claim data for a given member, provider, payer, etc. The users of the system may include a patient/pharmacy benefit member, a pharmacist, a pharmaceutical company, a medication prescriber. Each computing device may be a processor based device with memory, persistent storage, wired or wireless communication circuits and a display that allows each computing device to connect to and couple over the communication path 54 to the system 56. For example, each computing device may be a smartphone device, such as an Apple Computer product, Android OS based product, etc., a tablet computer, a personal computer, a terminal device, a laptop computer and the like. In one embodiment shown in FIG. 5, each computing device 52 may store an application in memory and then execute that application using the processor of the computing device to interface with the health system 56 and the pharmacy processing component 56A (such as the user interface shown in FIG. 9). For example, the application may be a typical browser application or may be a mobile application. In some embodiments, the pharmacy processing component 56A may have one or more application programming interfaces (APIs) that may be used each user to access the pharmacy benefits data and information.

The communication path 56 may be a wired or wireless communication path or a combination thereof that uses a secure protocol or an unsecure protocol. For example, the communication path 56 may be the Internet, Ethernet, a wireless data network, a cellular digital data network, a WiFi network and the like or a combination of one or more of the networks. The communication path 56 may use various communication protocols, such as TCP/IP, HTTP, HTTPS, etc., and various data format protocols, such as HMTL, JSON, etc. to permit each computing device 52 to connect to and exchange data with the pharmacy processing component 56A.

The health system 56 may provide various health related services and products such as permitting a user to search for a doctor and medical services thus providing a healthcare marketplace. The health system 56 may be implemented using one or more computer resources, such as one or more server computers, one or more cloud computing resources, one or more blade servers and/or discrete computer components including a processor, a memory, a persistent storage device and the like.

In the embodiment shown in FIG. 5, the health system 56 may house/host the pharmacy processing component 56A that may include a pharmacy processing pipeline as described below. The pharmacy processing component 56A may be implemented in software or hardware. When the pharmacy processing component 56A is implemented in software, the pharmacy processing component 56A may be a plurality of lines of computer code that may be stored in a memory and executed by a processor of the health system 56 to perform the functions and operations of the distributed pharmacy processing system and method as described below including providing the APIs. When the component 56A is implemented in software, the processor that executes the computer code is configured to perform the functions and operations of the distributed pharmacy processing system and method as described below including providing the APIs. When the pharmacy processing component 56A is implemented in hardware, the pharmacy processing component 56A may be one or more integrated circuits, FPGAs, microcontrollers, etc. that perform the functions and operations of the distributed pharmacy processing system and method as described below including providing the APIs. In other embodiments, the pharmacy processing component 56A may be implemented on a stand-alone computer system or a different computer architecture than shown in FIG. 5 and those other implementations are within the scope of the disclosure. For example, the pharmacy processing component 56A may be implemented using cloud computing components and a third party can access the functionality of the pharmacy processing component 56A using the APIs over the communication path 54.

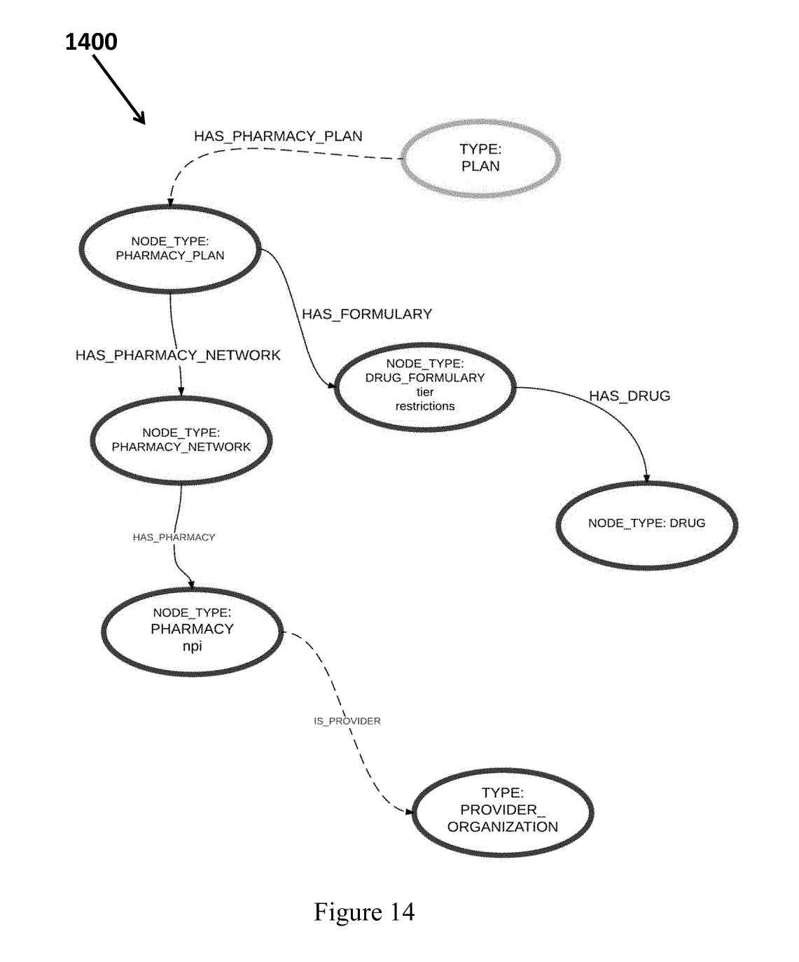

In one embodiment, the system 56 may further include a health graph component 56B that stores various healthcare information in a graph type model as is described in co-pending patent application Ser. No. 15/001,703 filed Jan. 20, 2016 which is incorporated herein by reference. An example of the graph storage for pharmacy data is shown in FIG. 14. The health graph component 56B may be implemented in software or hardware as described above.

The system 56 (or the pharmacy processing component 56A when the pharmacy processing component 56A is its own standalone system) may further include a data store 58 that stores various user data as well as health care data. Furthermore, when the system 56 includes the pharmacy processing component 56A, the data store 58 may further include drug formulary information, drug product information, user pharmacy information and pharmacy benefits and the like. The data store 58 may be implemented in software or hardware as described above. The system described may also be implemented using various different forms of data storage and the disclosure is not limited to the graph storage shown in FIG. 5.

In one embodiment, the pharmacy processing component 56A may provide APIs so that member pharmacy benefits and information is available via the APIs. The creation of APIs (application program interfaces) to this data allows software developers to create new applications using a member's pharmacy benefits without having to go through setting up all of the connections to PBMs, drug data sources, and formularies. This would spark more innovation in health technology. In one implementation, the APIs could accept and return JSON (JavaScript Object Notation) which is easy for humans to write and read. An enhanced X12 eligibility API may then include a member's medical benefits plus pharmacy benefits and accepts member information and a drug's NDC (national drug code) or drug name. The API may return, based on the member's pharmacy benefit and the formulary for the pharmacy benefit, whether the medication was covered (is NDC on formulary), tier level, prior authorization, step therapy, quantity limit, and estimated copay for 30-day supply at a preferred pharmacy. The in-network pharmacy API accepts member information, location, and a radius. It would return a list of in-network pharmacies that are in-network in the specified location and radius. Other APIs could return queries on the data included in the formulary data store, including but not limited to drug data, plan data, pharmacy data, etc.

Furthermore, pharmacy solutions can be built using the APIs. For example, these products could include software that allows the prescriber, member, pharmacist or other interested party to look up member benefits. As shown in FIG. 9, a formulary lookup tool would allow the user to look up medications that are preferred on the member's formulary. The following questions can be answered using the formulary lookup tool: Is my medication covered under my insurance? What tier is my medication? Does my medication have a prior authorization requirement? Step therapy? Quantity limit? What is my copay? What pharmacies are in network in my area? What medications are covered on a member's formulary for a disease state? What medications are covered on a member's formulary for a therapeutic class?

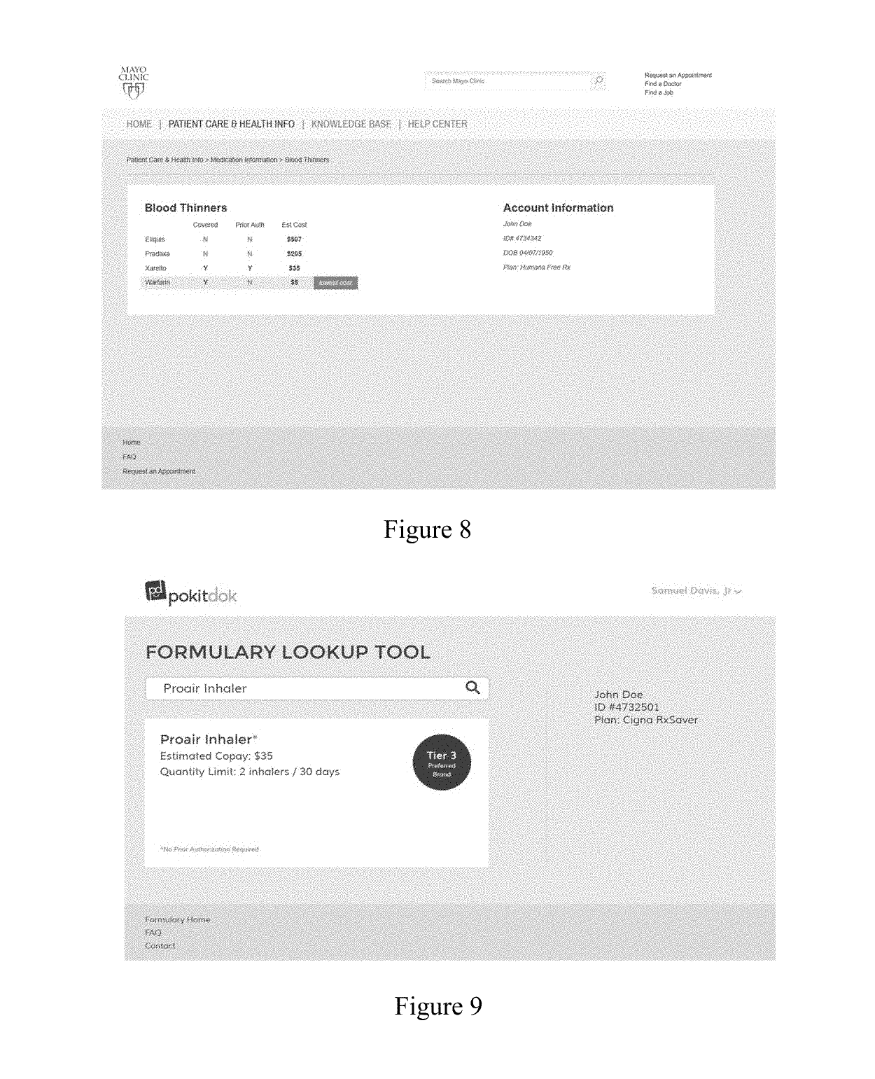

Other solutions could be medication specific. For example, as seen in FIG. 7, if a pharmaceutical company wanted to help members determine if a specific medication of the company is covered by the member's pharmacy benefit, a Pharmacy Benefit Eligibility API could return that information. This could power a front-end, such as a website or app (that may for example be delivered to the computing device 52) that allows the member to determine their copay for the medication. Another example, as seen in FIG. 8, is if a hospital wants to look up if a medication is covered before writing the discharge medications, they could by accessing the API. The lookup could be therapeutic class (ex. ACE inhibitors) or indication (ex. Hypertension) specific.

Using the pharmacy processing component 56A, prescriptions could be sent electronically from the prescriber to the pharmacy via NCPDP SCRIPT formatting language. Medication history for the member will be obtained electronically from the plan or PBM using past fill data. With the ability to add medication to e-prescribing, the software could detect dangerous drug interactions before the prescription is written. This is essential if the member doesn't tell the prescriber all of the medications they are taking that have been written by a different prescriber.

Member pharmacy benefits are typically isolated in silos. The pharmacy processing system and method would bring these data sources and transactions together such that pharmacy benefit information for a member's plan could be accessed electronically across these different sources. The essential data sources will include formularies, in network pharmacies, drug specific information, member medical benefits and member pharmacy benefits.

Using the pharmacy processing system and method, each different user may be able to answer the following:

Is my medication covered under member's insurance?

What tier is a specific medication?

Does the medication have a prior authorization requirement?

Is step therapy required?

Does a quantity limit apply?

What is the copay for a given member?

What pharmacies are in network for a given member?

What medications are covered on a member's formulary for a disease state?

What medications are covered on a member's formulary for a therapeutic class?

Formularies

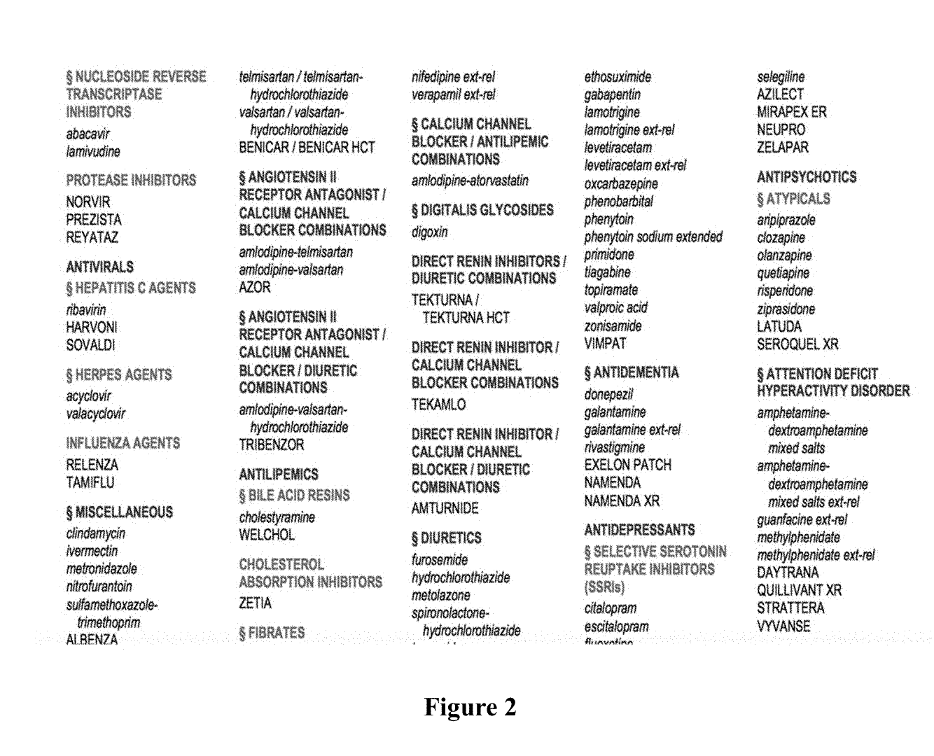

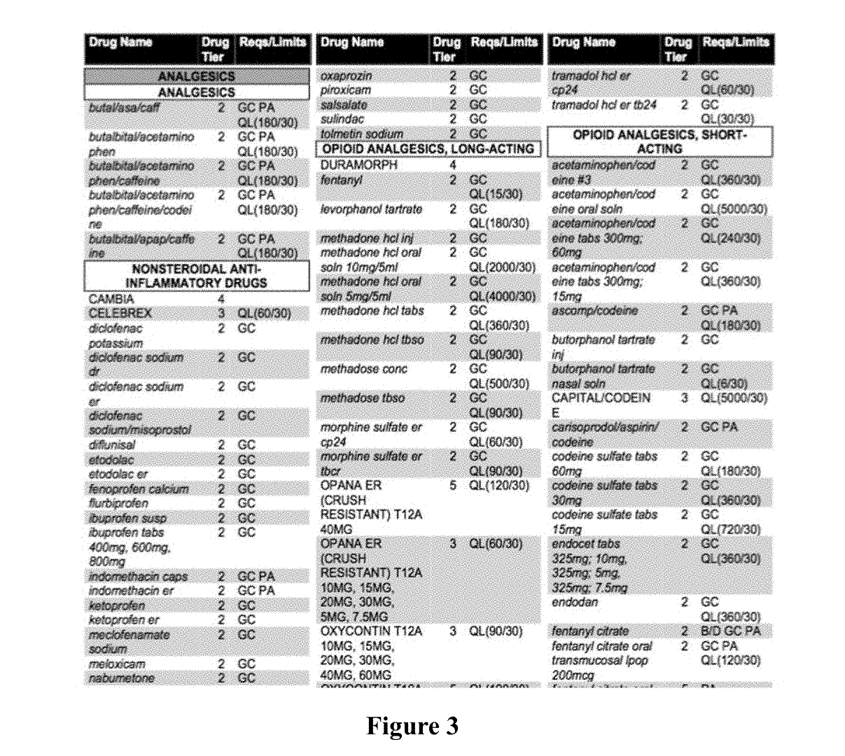

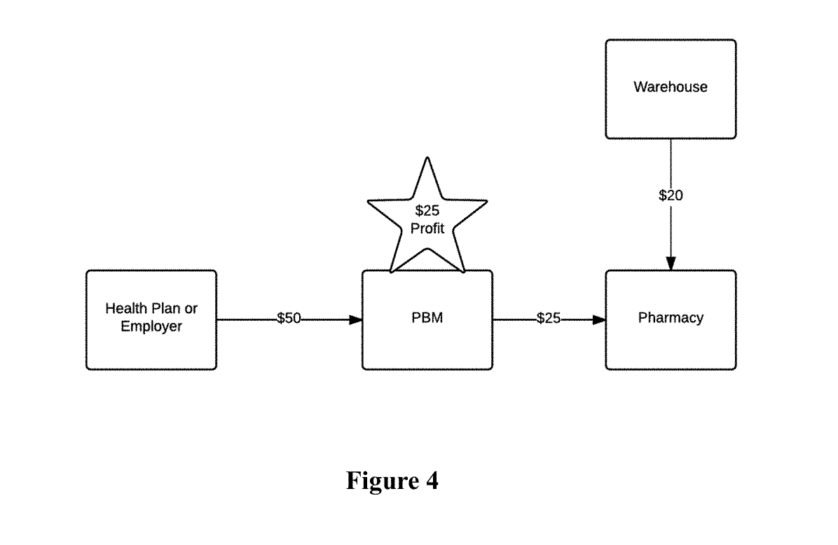

A formulary includes a list of medications that is covered under a health plan for a particular user/member such as shown in FIGS. 2 and 3 and described above. It may also include a tier level for the medication and restrictions for its use. The formulary can be made available in various formats from the PBM or health plan. This data would be stored such that it may be easily connected with other member and pharmacy information. The dynamic distributed pharmacy transactional network processing will have the ability to collect formularies from health plans nationwide, link them to relevant plans, and make them available electronically. In some embodiments, the formularies may be stored in the health graph.

In Network Pharmacies

In network pharmacies may be a dynamic list of in-network pharmacies that would also be stored for each pharmacy benefit plan. Pharmacy addresses are geocoded as they're stored to ensure easy access to in-network pharmacies based on a member's current geolocation.

Specific Drug Data

Specific drug information about each medication would be stored as well. This would include data such as drug name, strength, indication, pricing, etc.

Member Benefits

Member benefits include specific information about drug coverage. For example, the system may store if the member currently has benefits and copay information for each drug tier. This benefit information is obtained from the plan or PBM via an electronic connection. Once member benefits are obtained, it can be combined with the formulary data to determine coverage and copay for a specific medication.

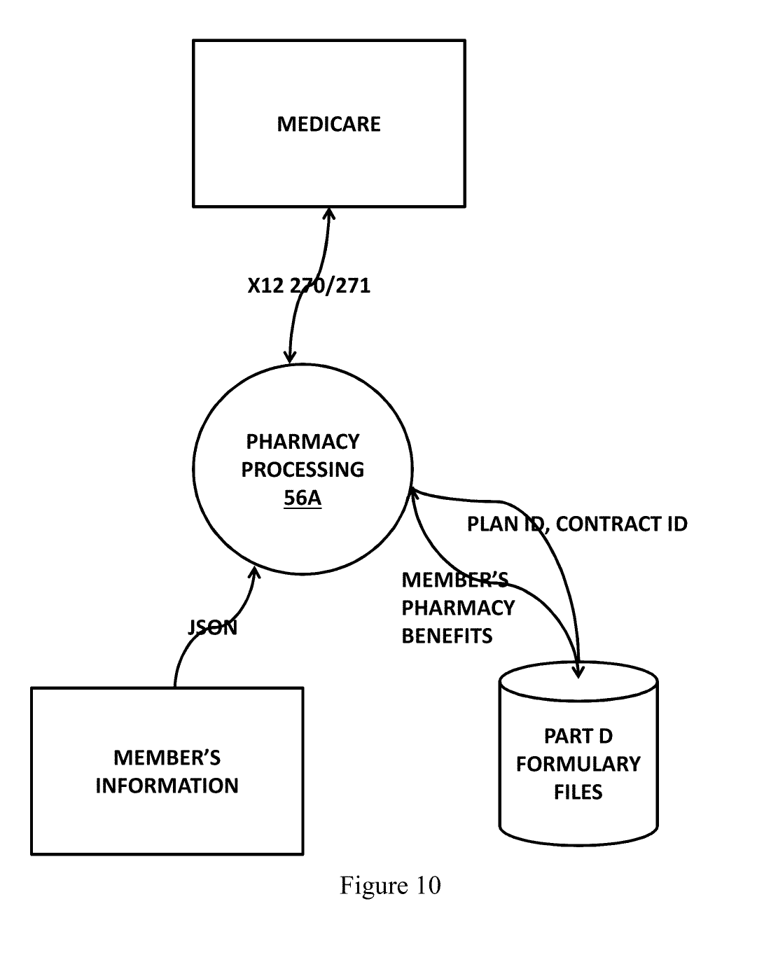

FIG. 10 illustrates an example of the distributed pharmacy transaction processing component 56A being used to access pharmacy plan IDs. The system/component 56A may be built using connections with various health plans, PBMs, brokers, health systems, pharmacy data companies and third party administrators to gain access to data feeds such as formularies, drug specific data and member medical and pharmacy benefits.

Formularies

Formularies are collected from different sources such as CMS, health plans, PBMs, brokers, etc via various formats (PDF, CSV or Formulary and Benefit Data Load in NCPDP format), stored in a formulary data store (that is part of the data store 58 shown in FIG. 5) and linked with member benefits, plan, and pharmacy data in the health graph data store 56B as shown in FIG. 5 that may also be stored in the data store 58.

The Formulary and Benefit Data Load would be obtained from the plan or the PBM and loaded into the formulary data store. Other formats of formularies obtained would be analyzed and uploaded into the formulary data store. The formulary would include drug names of covered medications, tier levels for each drug, and restrictions such as prior authorization, step therapy and quantity limits.

Drug Specific Data

The system and method may leverage connection with pharmaceutical companies to receive drug specific data such as brand name, generic name, strength, dosage form, therapeutic class and indication and this data may also be loaded into the health graph data store 56B. This would allow the ability to access additional information about a specific medication. For example, it would allow group of medications that treat hypertension that are covered under a member's formulary to be returned.

In Network Pharmacies

The system and method may use CMS Part D data to obtain in network pharmacy data such as national provider identifier (NPIs), pharmacy names, addresses and whether they are in network with a Part D health plan. Pharmacy network information would be stored in the health graph data store. This allows for easy access of geolocation of the pharmacy, pharmacy name, address, phone number, retail/mail order pharmacy, etc.

Member Medical and Pharmacy Benefits

The system and method may leverage electronic connections with health plans, PBMs, employers and other sources (trading partners) to link member medical benefits to pharmacy benefit information. As shown in FIG. 10, for Medicare Part D plans, this can be done if the Formulary ID or Plan Name and Location is known. If unknown, a member's plan information can be obtained via X12 270/271 eligibility connection to medical benefits. A member's card information (member id, name, date of birth) using a protocol, such as JSON, would be sent to a trading partner. PlanID and ContractID would be returned on the response along with other member medical coverage details. The PlanID and ContractID would be used to query into the member's formulary and benefit data in the Part D formulary files as shown in FIG. 10.

For commercial pharmacy plans, a connection to either the plan or the PBM needs to be made to access member specific benefits such as tier copayments. This information is linked to the member's formulary to determine a member benefit for a specific drug. For example, if a member is prescribed a medication like Lisinopril, we could reference the member's formulary to determine that Lisinopril is a tier 1 medication. Using the member's pharmacy benefit information, it is determined that tier 1 medications have a $10 copay. Combining both data sources, the system can determine that the member's copay for Lisinopril is $10.

The electronic connection to the PBM for member's benefits would be using the NCPDP E1 or X12 270/271 standards, depending on the formatting used by the PBM. Demographic data such as cardholder ID, last name, first name, date of birth, and zip code is provided to the PBM. Plan information such as payer ID, copay information, benefit effective date, and benefit termination date is returned on the NCPDP E1 or X12 270/271. A rejection code could also be returned if the member is not found.

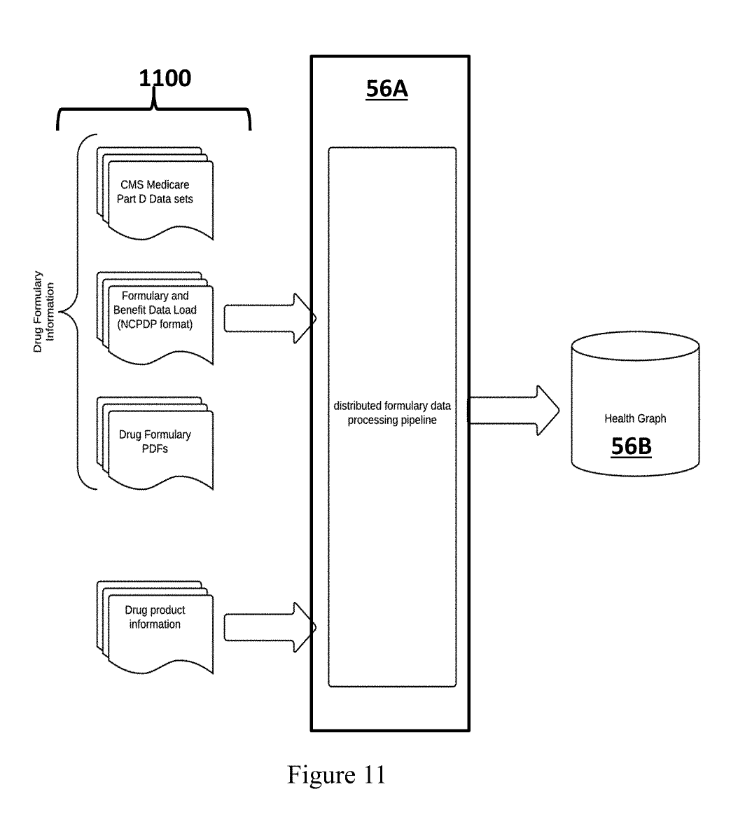

FIG. 11 illustrates more details of the distributed pharmacy transaction processing component 56A in an embodiment of the system in which the pharmacy benefit data is stored in the health graph 56B. As shown in FIG. 11, the distributed pharmacy transaction processing component 56A may receive data from one or more data sources 1100, process that data and store it in the health graph 56B. The one or more data sources may include CMS Medicare Part D data sets, formulary and benefits data load (in NCPDP format), drug formulary PDFs and drug product information. The dynamic distributed pharmacy transactional network processing 56A is enabled by enhancing the health graph data store 56B, an example of which is shown in FIG. 14. The health graph data store 56B may store the member benefit information, pharmacy and drug formulary information. Drug formulary information is found in a variety of formats and systems making it difficult to process when a member or healthcare provider needs to answer simple pharmacy benefit questions. To address that, formulary data in all of the commonly available formats (including PDFs provided to members directly) may be input to a distributed formulary data processing pipeline as shown in FIG. 11 that analyzes this information and merges it with drug product information. The information discovered in these data files is then linked with related data in the health graph data store as shown in the example in FIG. 14. As new formularies are published, they are processed in real time and included in the health graph.

The system and method has the ability to collect, store and manage formulary data within a distributed formulary data processing pipeline that is part of the pharmacy processing component 56A shown in FIG. 5. The distributed formulary data processing pipeline analyzes incoming formulary files for National Drug Code (NDC) or other drug product information (name, dosage, form) and merges matching drug product information with each formulary entry.

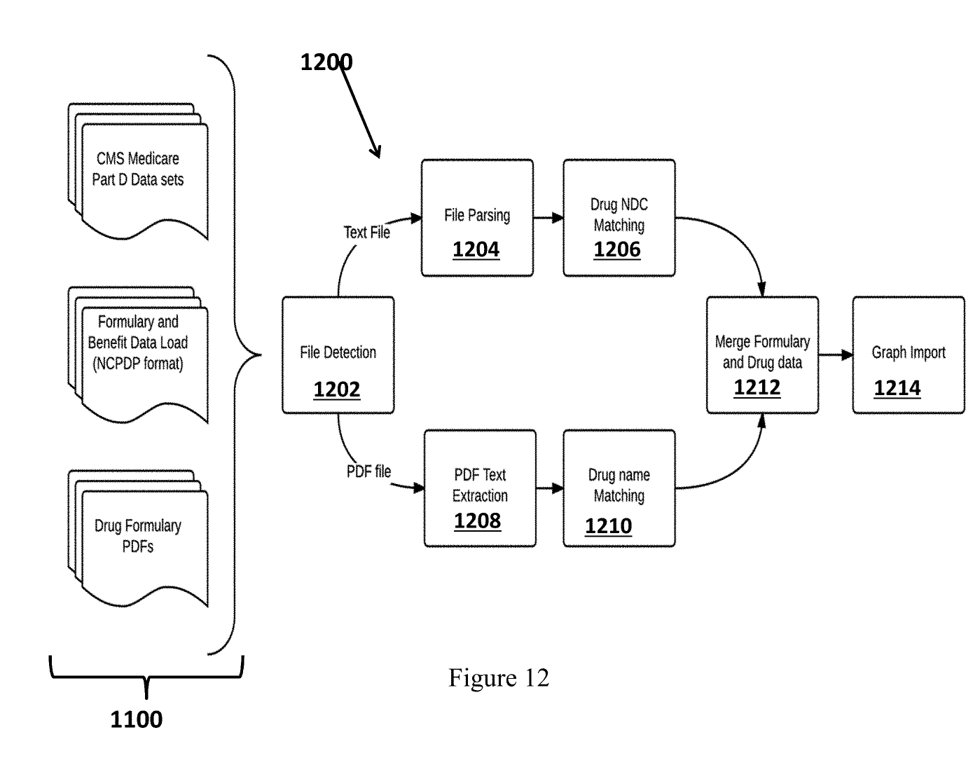

FIG. 12 illustrates a method 1200 for distributed pharmacy transaction processing. As files from the one or more data sources 1100 are introduced into the distributed formulary data processing pipeline, they move through a series of steps based on the type of file that's being processed based on a type of file detected (1202). If the file is detected to be a text file, the method may perform file parsing (1204) and drug NDC matching (1206) so that the data from the text file from the formulary may be merged with the drug data (1212) and may be imported into a health graph (1214). An example of a resulting health graph is shown in FIG. 14. When a PDF file is detected (1202) which may be a PDF file containing formulary information, the method (implemented by the pipeline processing) detects that they do not match any of the known text-based formulary data formats so they move into a pipeline stage focused on PDF text extraction (1208) which may be performed using various known methods and systems. Since formulary PDF formatting varies across drug plans, drug name matching (1210) may be used to align the text data extracted from the PDF files with drug product information. Known drug formulary formats are parsed and aligned with drug product information via National Drug Code (NDC). When formulary information has been mapped to drug product information (1212), it's merged into JavaScript Object Notation (JSON) and delivered for input to the health graph (1214).

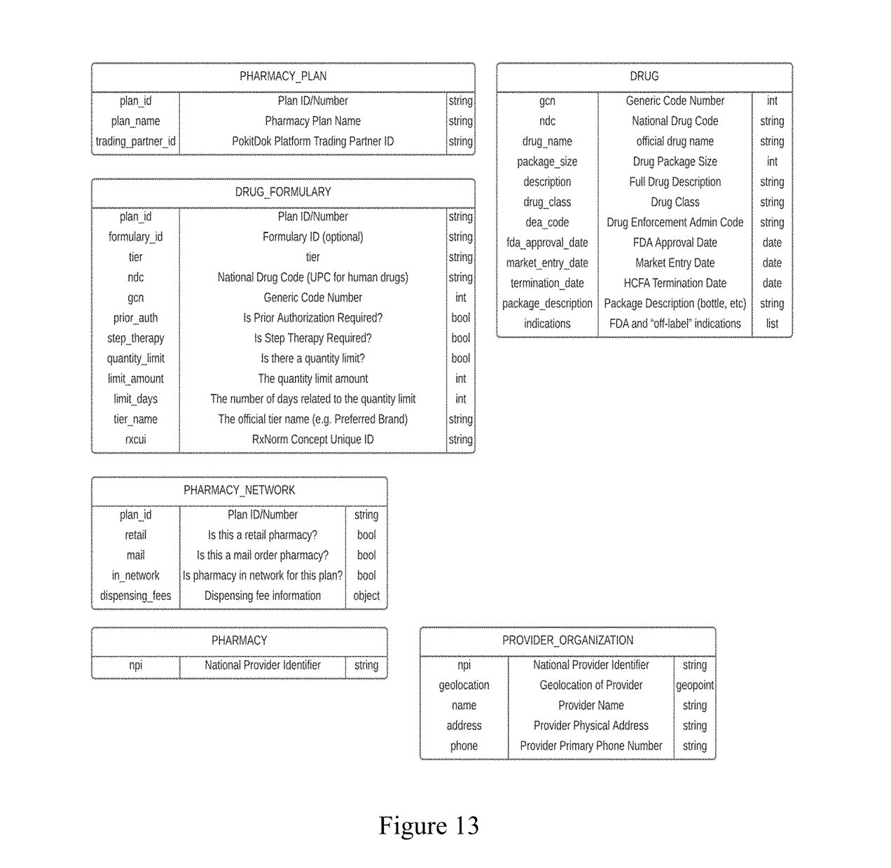

FIG. 13 illustrates an example of a drug formulary and product information in a JSON data format that may be used by the distributed pharmacy transaction processing component. More specifically, FIG. 13 illustrates an example of a JSON structure into which the drug formulary and drug product information may be mapped.

FIG. 14 illustrates pharmacy plan information stored in a health graph data store in a health graph 1400 that may be part of the health system shown in FIG. 5. As formulary entries are processed, new nodes and edges are added to the pharmacy portion of the health graph data store 56B using the generated JSON structures shown in FIG. 13. Each new node in the graph will contain the same key value pairs that are outlined on the JSON documents in FIG. 13. Each new pharmacy plan that's discovered will yield a new PHARMACY_PLAN node as shown in FIG. 14. The new PHARMACY_PLAN node will be associated with the corresponding medical plans that reference it from prior X12 271 transactions. This will be done when matching plan ids are found between medical and pharmacy plans. When a matching PLAN node is found for a PHARMACY_PLAN node, an HAS_PHARMACY_PLAN edge will be created between the matching nodes. Each new drug formulary entry for a given pharmacy plan will yield a DRUG_FORMULARY node as shown in FIG. 14. This node will be linked via HAS_FORMULARY and HAS_DRUG edges between the associated PHARMACY_PLAN and DRUG nodes. The DRUG_FORMULARY nodes will contain properties specific to that pharmacy plan for a given drug. This is where step therapy, quantity limits and other restrictions are recorded. DRUG nodes contain properties related to a specific drug product. Drug name, form, dosage, and manufacturer information is stored on these nodes. PHARMACY_PLAN nodes are also linked with PHARMACY_NETWORK nodes via HAS_PHARMACY_NETWORK edges. Each PHARMACY_NETWORK node contains properties related to a pharmacy that's included in that drug plan's network. PHARMACY_NETWORK nodes contain properties related to drug dispensing fees and indicators about mail order and retail status. PHARMACY_NETWORK nodes are linked to PHARMACY nodes via HAS_PHARMACY edges. Each PHARMACY node represents a unique pharmacy. PHARMACY nodes are linked to PROVIDER_ORGANIZATION nodes via IS_PROVIDER edges such that existing geolocation information found for provider organizations may be used for quick geolocation pharmacy network searches. PHARMACY nodes and PROVIDER_ORGANIZATION nodes are associated via matching National Provider Identifier (NPI) values.

With drug formulary information now consolidated in the health graph data store and linked with drug product information, the system can use it to augment healthcare transactions dynamically as they are processed. When standard X12 270/271 transactions are processed to determine insurance eligibility for a member, the benefits information can be dynamically augmented based on the information returned in the X12 271 transaction. For example, consider these X12 271 data segments that are returned for a member with a Prescription Drug Plan:
EB*R**88*OT˜
REF*18*55820 003˜
DTP*292*D8*20100201˜
LS*2120˜
NM1*PR*2*UNITEDHEALTHCARE INSURANCE COMPANY˜
N3*450 Columbus Blvd.˜
N4*Hartford*CT*061030450˜
PER*IC**TE*8778423210*UR*www.AARPMedicareRx.com˜
LE*2120˜

When those data segments are processed using the dynamic transactional data streaming (disclosed in more detail in U.S. patent application Ser. No. 14/466,907, filed on Aug. 22, 2014 and entitled “SYSTEM AND METHOD FOR DYNAMIC TRANSACTIONAL DATA STREAMING”, the entirety of which is incorporated herein by reference), the system may end up with a processed JSON response that includes this information:

```
“pharmacy”: {
  “benefits_manager”: {
    “name”: “UNITEDHEALTHCARE INSURANCE COMPANY”,
    “phone”: “8778423210”,
    “url”: “www.AARPMedicareRx.com”
  },
  “is_eligible”: true,
  “plan_number”: “S5820 003”
}
```

Given the above, a query for eligibility of a drug to the health graph may be:

```
drug_name = EligibilityDSL.EligibilityRequest
        .formularyRequest
        .drugName.toList( )
plan_number =
      EligibilityDSL.EligibilityRequest
        .pharmacyData
        .plan_number.next( )
```

Given the above, a query for the formulary would involve:

```
    a. convert drug name to ndc number:
ndc =
  g.V.has(‘node_type’,’drug’)
    .has(‘drug_name’, drug_name)
    .in(‘has_drug’).outV.as(‘drug_formulary’)
    .ifThenElse
        {it.outV.has(plan_number, plan_number)}
            {it.ndc}
            {None}
    b. use ndc to search the formulary files to determine coverage (is
    covered? is auth?)
    is_covered = g.V.has(‘node_type’,’drug_formulary’)
                .has(‘ndc’, ndc)
                .is_covered.next( )
    is_authorized = g.V.has(‘node_type’,’drug_formulary’)
                .has(‘ndc’, ndc)
                .is_authorized.next( )
    c. if covered, find an in net pharmacy
    if is_covered:
        in_network_pharms =
        g.V.has(‘node_type’,’pharmacy_plan’)
          .has(‘plan_number’, plan_number)
          .out(‘has_pharmacy_network’).inV
          .out(‘has_pharmacy’).inV
          .pharmacy_name.toList( )
```

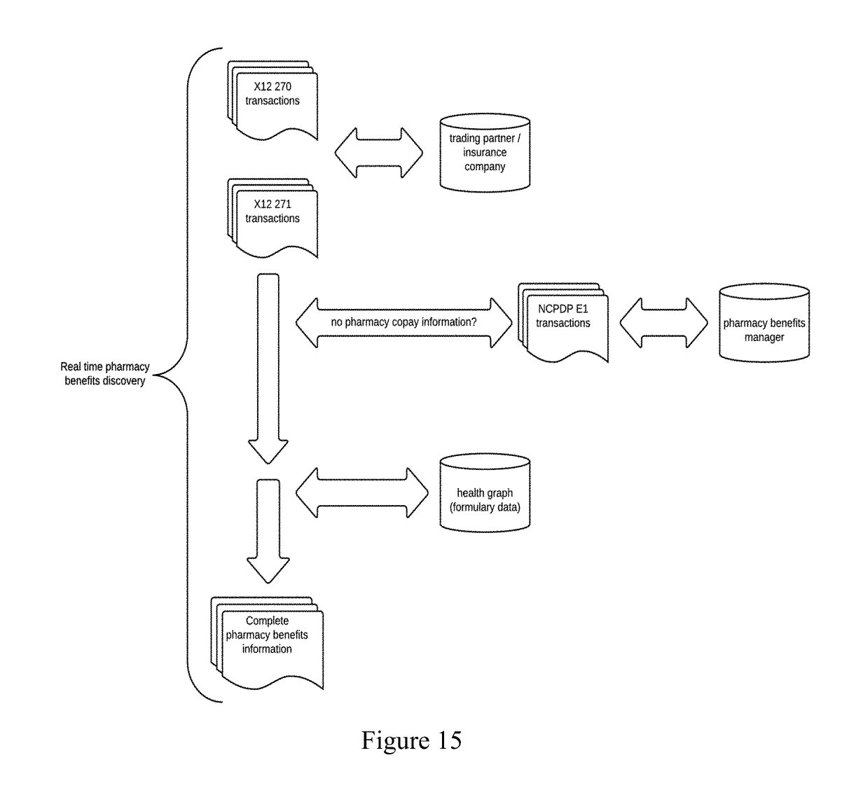

FIG. 15 illustrates an example of drug formulary information linked with drug product information that may be achieved using the distributed pharmacy transaction processing component. Thus, when pharmacy benefit coverage is indicated in the X12 271 transaction by the presence of an active pharmacy benefit (EB) data segment but no copay or deductible information is returned for the pharmacy benefits, the system can dynamically construct a National Council for Prescription Drug Programs (NCPDP) Eligibility Verification (E1) transaction to request those missing details from the appropriate information source such as the PBM via information found in the X12 271 transaction as shown in FIG. 15. The benefits_manager data combined with the plan_number allows us to link the X12 271 transactional data with the appropriate formulary information found in the formulary data store. The combined X12 271 data plus the NCPDP E1 response data is then merged with the matching formulary data for a complete view of the member's pharmacy benefits.

As another example, when a member or prescriber needs to confirm that a drug is covered by a member's pharmacy plan/benefit, they can quickly cross reference the member's prescription drug plan formulary along with their current member information. For example, a health care provider decides that a member should be prescribed Ventolin. Given the member's pharmacy benefit information and the drug name or national drug code (NDC) value, the health care provider, using the pharmacy processing system and method described above, can query the system and quickly determine if Ventolin is covered by the insurance of the member. If the member has a Medicare Part D prescription drug plan and their plan number is S5820 003, the provider's request to the formulary data store of the system (for the formulary associated with the particular drug plan) will quickly show that Ventolin is not covered by this drug plan. The provider knows that there's an alternative medication, Proair, that will also work for this member. Another quick check of the formulary data store of the system for the medicare part D plan S5820 003 shows that Proair is covered by the plan. An example response for Proair from the pharmacy processing system may be:

```
{
    “formulary_id”: “00016002”,
    “ndc”: “59310-0579-22”,
    “prior_auth”: false,
    “quantity_limit”: 0,
    “step_therapy”: false,
    “tier”: 3,
    “tier_name”: “preferred brand”
  }
```

The above interaction allows the prescriber to avoid any hassles for the member and the pharmacy by selecting a covered drug before ever writing the prescription. Now consider a scenario where a prescriber did not check the formulary data store prior to authoring the prescription for Ventolin. When the member arrives at the pharmacy, the pharmacist can still use the formulary data store of the system to check Ventolin and then, due to the data, inform the member that Ventolin is not covered but that an alternative, Proair, is covered by the member's drug plan. The pharmacist can then work with the prescriber to fill the appropriate medication for the member.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A pharmacy system, comprising:
a computer system having a processor;
a pharmacy benefits component, executed by the processor, that stores a pharmacy benefit for a particular member, information about a medical coverage of the particular member including the pharmacy benefit of the particular member and a formulary for the pharmacy benefit for the particular member, the formulary listing a plurality of medications covered by the pharmacy benefit for the particular member; and
the pharmacy benefits component receiving a request to access, by an entity associated with the particular member, the pharmacy benefit information for the particular member and that is capable of generating, in response to the request for access to the pharmacy benefit information for the particular member and based on the pharmacy benefit of the particular member, an indication of whether a medication is covered by the pharmacy benefit of the particular member, a tier level of a medication that is covered by the pharmacy benefit of the particular member, a prior authorization requirement for a medication that is covered by the pharmacy benefit of the particular member, a step therapy for a medication that is covered by the pharmacy benefit of the particular member, a quantity limit for a medication that is covered by the pharmacy benefit of the particular member, and an estimate co-pay for a medication that is covered by the pharmacy benefit of the particular member; and
wherein the pharmacy benefits component displays, to a user, whether the medication is covered by the pharmacy benefit of the particular member.

2. The system of claim 1 further comprising a health graph store into which the pharmacy benefit and the formulary are stored.

3. The system of claim 1, wherein the device accesses the pharmacy benefit information using an application programming interface.

4. The system of claim 1, wherein the entity is a member who has the pharmacy benefit.

5. The system of claim 1, wherein the entity is a prescriber and a device provides information to determine if a medication is covered to the prescriber.

6. The system of claim 1, wherein the entity is a pharmacist and a device provides information to determine a therapeutic alternative to a rejected medication.

7. The system of claim 1, wherein the entity further comprises one of an employer and a medication manufacturer.

8. The system of claim 4, wherein the pharmacy benefit further comprises an out of pocket costs and the member looks up covered prescriptions and out of pocket cost for a covered medication.

9. A pharmacy method, comprising:
storing pharmacy benefits for a particular member, information about a medical coverage of the particular member including the pharmacy benefit of the particular member and a formulary for the pharmacy benefit for the particular member, the formulary listing a plurality of medications covered by the pharmacy benefit for the particular member;
receiving, at a pharmacy benefits component that stores the pharmacy benefits of the particular member, a request to access, by an entity associated with the particular member, the pharmacy benefit information for the particular member; and
generating, by the pharmacy benefits component in response to the request for access to the pharmacy benefit information for the particular member and based on the pharmacy benefit of the particular member, an indication of whether a medication is covered by the pharmacy benefit of the particular member, a tier level of a medication that is covered by the pharmacy benefit of the particular member, a prior authorization requirement for a medication that is covered by the pharmacy benefit of the particular member, a step therapy for a medication that is covered by the pharmacy benefit of the particular member, a quantity limit for a medication that is covered by the pharmacy benefit of the particular member, and an estimate co-pay for a medication that is covered by the pharmacy benefit of the particular member; and
displaying, to a user, whether the medication is covered by the pharmacy benefit of the particular member.

10. The method of claim 9, wherein storing the pharmacy benefits further comprises storing the pharmacy benefits and the formulary in a health graph store.

11. The method of claim 9, wherein accessing the information further comprises accessing the pharmacy benefit information using an application programming interface.

12. The method of claim 9, wherein the entity is a member who has the pharmacy benefit.

13. The method of claim 9, wherein the entity is a prescriber and accessing the information further comprises accessing information to determine if the medication is covered for the prescriber.

14. The method of claim 9, wherein the entity is a pharmacist and accessing the information further comprises accessing information to determine a therapeutic alternative to a rejected medication.

15. The method of claim 9, wherein the entity further comprises one of an employer and a medication manufacturer.

16. The method of claim 12, wherein the pharmacy benefit further comprises an out of pocket costs and the member looks up covered prescriptions and out of pocket cost for a covered medication.

17. A method for/an application programming interface for pharmacy benefits, comprising:
receiving, at a pharmacy benefit store that stores a pharmacy benefit for a member, a member identifier and a medication identifier, wherein the member identifier identifies a member covered by the pharmacy benefit and the medication identifier identifies a medication the pharmacy benefit including a formulary for the pharmacy benefit for the particular member, the formulary listing a plurality of medications covered by the pharmacy benefit for the particular member; and
returning, via an application programming interface that accesses the pharmacy benefit store, one or more pieces of information about the pharmacy benefit for the member, the one or more pieces of information being a medication covered by the pharmacy benefit, a tier level of the covered medication, a prior authorization for the covered medication, a step therapy for the covered medication, a quantity limit for the covered medication and an estimated co-pay for the covered medication.

18. The method of claim 17, wherein the application programming interface returns an in-network pharmacy for the covered medication.
